(19) United States
(12) Patent Application Publication
(10) Pub. No.: US 2026/0258902 A1
(43) Pub. Date: Sep. 3, 2026

(54) VALVE-ACTUATED SUCTION APPARATUS WITH ROTATION-PREVENTING PLUNGER VALVE

(71) Applicant: Israel Harry Zimmerman, Los Angeles, CA (US)

(72) Inventor: Israel Harry Zimmerman, Los Angeles, CA (US)

(21) Appl. No.: 19/366,043

(22) Filed: Oct. 22, 2025

Related U.S. Application Data
(63) Continuation-in-part of application No. 19/036,654, filed on Mar. 3, 2025.

(51) Int. Cl. F16M 13/02; F16K 24/06

(52) U.S. Cl. CPC F16M 13/022; F16K 24/06

(57) ABSTRACT

A valve-actuated suction apparatus includes an elastomeric seal member arranged to seal against a surface and having a vent port extending therethrough. A collar has a collar opening extending therethrough that is aligned and in fluid communication with the vent port. A plunger valve is slidably arranged in the collar opening in a manner that prevents rotation of the plunger valve relative to the collar. The plunger valve is slidable between a plunger valve closed position and a plunger valve open position to selectively seal and unseal the seal member vent port. During use, the seal member may be pressed into sealing contact with a surface. The plunger valve may be pressed into its closed position to thereby seal the vent port. Should an attempt be made to rotate the plunger valve relative to the collar, rotation will be prevented due to the plunger valve rotation prevention design.

### CROSS-REFERENCE TO RELATED APPLICATIONS

This application is a continuation-in-part under 35 U.S.C. 120 of U.S. patent application Ser. No. 19/036,654, filed Mar. 3, 2025. The contents of said patent application are incorporated herein by this reference in their entirety.

### BACKGROUND

### 1. Field

The present disclosure relates to suction apparatus that can be releasably secured to surfaces. More particularly, the disclosure concerns suction apparatus with anchor members that adhere to surfaces by way of differential pressure when flexed. Still more particularly, the disclosure pertains to suction apparatus with quick-release differential pressure venting.

### 2. Description of the Prior Art

By way of background, suction apparatus that operate by way of differential pressure are known. Such apparatus often utilize resilient anchor members such as suction cups. A suction cup typically includes a flexible seal member configured as an elastomeric dome-shaped structure having a concave lower side and a relatively soft peripheral rim. In order to adhere the suction cup to a reference surface, the seal member must be affirmatively flexed by pressing it against the reference surface with enough force to temporarily flatten the concave lower side so that air is expelled outside the peripheral rim. When the pressing force is released, the seal member has a natural tendency to return to its initial dome shape. As this rebounding occurs, the volumetric cavity that lies inside the peripheral rim between the seal member's lower side and the reference surface begins to enlarge. This in turn causes the air pressure in the volumetric cavity to proportionally decrease in accordance with Boyle's Law. A pressure differential is generated in which the pressure within the volumetric cavity is lower than the ambient air pressure outside the cavity, thereby resulting in a partial vacuum. The partial vacuum produces a suction force that increases until an equilibrium condition is reached wherein the elastic forces tending to return the seal member to its initial concave configuration are balanced by the vacuum forces. Attempts to pull the suction cup away from the reference surface will only increase the size of the volumetric cavity and further decrease the air pressure therein. The resultant suction force will continue to increase until the pulling force becomes large enough to break the seal between the seal member's peripheral rim and the reference surface.

A disadvantage of conventional suction cups is that the material stiffness and hardness needed to maintain the seal member's dome-shaped configuration tends to compromise its seal-forming ability. This limits the effective anchoring capability of the suction apparatus. On the other hand, for suction cups that are capable of developing a strong seal, many such devices lack the ability to easily release the suction force. These suction cups are designed to be released by peeling the edge of the suction cup. This may be difficult for many users, and some suction apparatus vendors have even recommended the use of a thin pry tool to help break the suction cup edge seal.

It is to improvements in the design of suction apparatus that the present disclosure is directed.

### SUMMARY

A valve-actuated suction apparatus includes an elastomeric seal member arranged to seal against a surface and having a vent port extending therethrough. A collar has a collar opening extending therethrough that is aligned and in fluid communication with the vent port. A plunger valve is slidably arranged in the collar opening in a manner that prevents rotation of the plunger valve relative to the collar. The plunger valve is slidable between a plunger valve closed position and a plunger valve open position to selectively seal and unseal the seal member vent port.

In another aspect, a method of using a valve-actuated suction apparatus, as summarized above, includes (in any order): (A) adhering the valve-actuated suction apparatus to a surface by placing the seal member against the surface so that the seal member is in sealing contact with the surface, (2) pressing the plunger valve into the plunger valve closed position to thereby seal the vent port, and (3) attempting to rotate the plunger valve relative to the collar while being prevented from doing so due to the plunger valve being slidably arranged in the collar opening in a manner that prevents rotation of the plunger valve relative to the collar.

### BRIEF DESCRIPTION OF THE DRAWINGS

The foregoing and other features and advantages will be apparent from the following more particular description of example embodiments, as illustrated in the accompanying Drawings.

FIG. 1 is a rear perspective view of a valve-actuated suction apparatus that may be constructed according to an example embodiment, with the suction apparatus facing a reference surface to which the suction apparatus is to be suction-adhered.

FIG. 2 is a front perspective view of the suction apparatus of FIG. 1, with the suction apparatus facing a reference surface to which the suction apparatus is to be suction-adhered.

FIG. 3 is a rear elevation view of the suction apparatus of FIG. 1.

FIG. 4 is a top view of the suction apparatus of FIG. 1.

FIG. 5 is an exploded perspective view of the suction apparatus of FIG. 1.

FIG. 6 is an enlarged exploded perspective view showing detail “Y” of FIG. 5.

FIG. 7 is a cross-sectional view taken along line “U-U” in FIG. 3, with the suction apparatus in a vacuum venting configuration.

FIG. 8 is a cross-sectional view taken along line “U-U” in FIG. 3, with the suction apparatus in a vacuum sealing configuration.

FIG. 9 is a cross-sectional view taken along line “W-W” in FIG. 3, with the suction apparatus in a vacuum venting configuration.

FIG. 9A is a cross-sectional view corresponding to FIG. 9, but depicting an alternative embodiment of the disclosed suction apparatus having a unitary seal member and collar, with the alternative suction apparatus in a vacuum venting configuration.

FIG. 10 is a cross-sectional view taken along line “W-W” in FIG. 3, with the suction apparatus in a vacuum sealing configuration.

FIG. 10A is a cross-sectional view corresponding to FIG. 10, but depicting an alternative embodiment of the disclosed suction apparatus having a unitary seal member and collar, with the alternative suction apparatus in a vacuum sealing configuration.

FIG. 11 is an enlarged cross-sectional view showing detail “Z” of FIG. 9.

FIG. 11A is an enlarged cross-sectional view corresponding to FIG. 11, but depicting an alternative embodiment of the disclosed suction apparatus having a unitary seal member and collar.

FIG. 12 is a cross-sectional view taken along line “U-U” in FIG. 3, with the suction apparatus in a vacuum venting configuration prior to engagement with a reference surface.

FIG. 13 is a cross-sectional view taken along line “U-U” in FIG. 3, with the suction apparatus in a vacuum sealing configuration while a stiffener member of the suction apparatus is deformed by a stiffener member flexing force in order to flatten a suction apparatus seal member against a reference.

FIG. 14 is a cross-sectional view taken along line “U-U” in FIG. 3, with the suction apparatus in a vacuum sealing configuration while a stiffener member of the suction apparatus undergoes elastic rebound following removal of a stiffener member flexing force in order to camber a seal member of the suction apparatus and thereby generate a negative pressure differential between the seal member and a reference surface.

### DETAILED DESCRIPTION OF EXAMPLE EMBODIMENTS

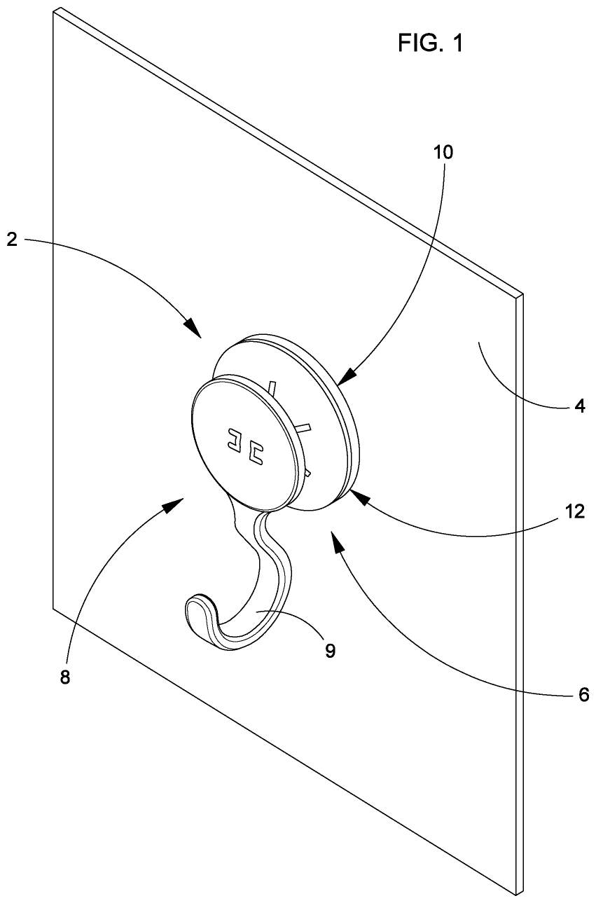

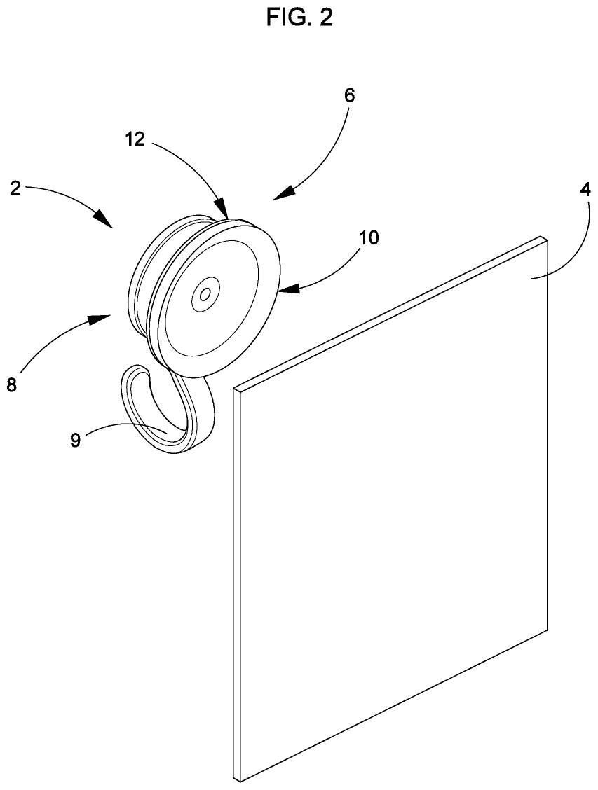

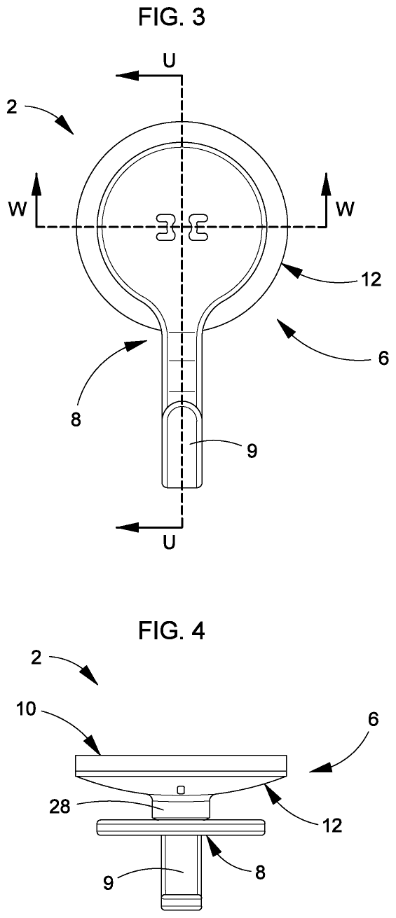

Turning now to the drawing figures, in which like reference numbers illustrate like structure in all the several views, FIGS. 1-4 illustrate one possible embodiment a valve-actuated suction apparatus 2 that may be constructed in accordance with the present disclosure. The suction apparatus 2 may be used for various applications, including to hold, carry or restrain one or more items or materials, particular on a vertical or near-vertical surface, or even on the underside of a horizontal surface. Advantageously, the suction apparatus 2 provides quick-release and attachment capability that allows the apparatus to be secured to a reference surface 4 and quickly released therefrom as needed. Although the reference surface 4 is shown as being substantially vertical (such as a wall, door, window, etc.), it could also be substantially horizontal and either upwardly facing (such as a tabletop or countertop) or downward facing (such as a ceiling, the underside of a table, etc.). The reference surface 4 could also have an orientation lying somewhere between vertical and horizontal.

In the illustrated embodiment, the suction apparatus 2 includes a base seal assembly 6 and a push-pull member 8 that operates as a suction control valve. The push-pull member 8 also serves as a carrier for directly or indirectly holding, carrying or restraining an object or material to be anchored by the suction apparatus. By way of example only, the illustrated embodiment depicts the push-pull member 8 as including a downward-depending hook member 9 that can be used to suspend an item, such as on a vertical or near-vertical surface. In alternative embodiments (not shown) the push-pull member 8 could be configured with other desired holding, carrying or restraining structures, the specific configuration of which will be dictated by the end use application for which the suction apparatus 2 will be used.

As can be seen in FIGS. 1, 2 and 4, the base seal assembly 6 includes an elastomeric seal member 10 and a flexible stiffener member 12.

The seal member 10 may be formed of a non-porous resilient material, such as injection-moldable rubber of relatively low hardness and density to maximize its ability to deform and seal against the reference surface 4. For example, silicone rubber with a shore hardness of between Shore A 0 to Shore A 20 may be used, with Shore A 10 rubber having been found to produce very satisfactory results. Other hardness values may also be suitable depending on the application for which the suction apparatus 2 is used.

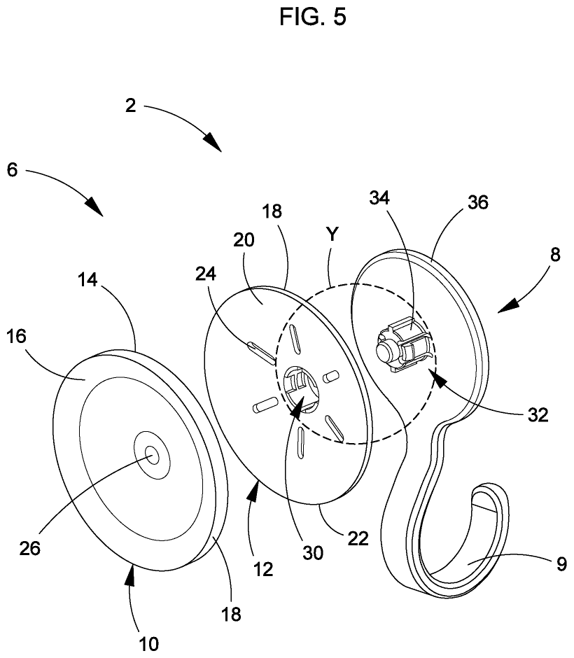

With additional reference to FIG. 5, the seal member 10 has a seal member outer side 14 that engages the stiffener member 12, a seal member inner side 16 that engages the reference surface 4, and a continuous seal member peripheral edge 18 of circular (or other) shape that defines an outer periphery of the seal member.

The stiffener member 12 may be formed of an elastically deformable material such as an injection-moldable thermoplastic or thermoset plastic. An elastically deformable metal could also be used. As shown in FIG. 5, the stiffener member 12 has a stiffener member outer side 18, a stiffener seal member inner side 20 that engages the seal member outer side 14, and a stiffener member peripheral edge 22 of circular (or other) shape that defines an outer periphery of the stiffener member.

The stiffener member 12 is configured as a cambered structure that is deformable in response to the application of a stiffener member flexing force directed against the stiffener member in the direction of the reference surface 4. The stiffener member 12 is configured to respond to the stiffener member flexing force by elastically deforming from an initial unflexed cambered state in which the stiffener member inner side 20 defines a concavity, to a flattened flexed state in which the stiffener member inner side concavity is wholly or partially eliminated. The stiffener member 12 is configured to elastically rebound from its flattened flexed state to its unflexed cambered state in response to removal of the stiffener member flexing force.

In the illustrated embodiment, the stiffener member peripheral edge 22 is continuous and the stiffener member outer side 18 is generally evenly spaced from the stiffener member inner side 20. In this configuration, the stiffener member 12 forms a shallow bowl-like or dish-like structure. This can be seen in FIGS. 4 and 5. The stiffener member 12 may likewise be thought of as a continuously curved domed structure. In an alternative configuration, the stiffener member 12 could be formed as a beveled structure, with the stiffener member inner side 20 having one or more beveled faces. In other embodiments (not shown), the stiffener member peripheral edge 22 may not necessarily be continuous. For example, the stiffener member 12 may be segmented, such as by virtue of having radial fingers.

The stiffener member 12 is integrated with the seal member 10 such that the base seal assembly 6 forms a two-component composite structure, with additional components also being addable if desired (such as one or more additional sealing and/or stiffening layers).

Due to the inherent elastomeric flexibility of the seal member 10, the stiffener member 12 imparts a camber to the seal member when the stiffener member is in its unflexed cambered state. This results in the seal member inner side 16 defining a concavity relative to the reference surface 4. Likewise, the stiffener member 12 flattens the seal member 10 when the stiffener member is elastically deformed by application of the stiffener member flexing force into its flattened flexed state. When the stiffener member flexing force is removed, the stiffener member 12 elastically rebounds from its flattened flexed state toward its cambered unflexed state. This in turn draws back the seal member 10 toward its initial cambered state to re-establish a concavity on its inner side 16. The seal member 10 will develop a suction force as it cambers away from the reference surface 4, and the cambering will continue until the stiffener member's rebound force and the suction force are in equilibrium with each other.

The stiffener member 12 may be integrated with the seal member 10 in any suitable manner that enables the stiffener member to influence the shape of the seal member. For example, the stiffener member 12 may be integrated with the seal member 10 by way of mechanical or adhesive attachment, co-molding, overmolding, or using other joining techniques.

In the illustrated embodiment, the suction apparatus 2 is fabricated using overmolding to integrate the stiffener member 12 with the seal member 10. For example, the stiffener member 12 may be molded first in a primary molding operation and the seal member 10 may be molded onto the stiffener member in a secondary molding operation. As depicted in FIG. 5, the stiffener member 12 may be formed with flow ports 24 (six are shown) into which the material of the seal member 10 will flow during the secondary molding operation to provide robust attachment points. Thus formed, the stiffener member 12 and the seal member 10 define an integrated laminate structure with the stiffener member inner side 20 being in direct interfacial engagement with the seal member outer side 14.

In other embodiments (not shown), the seal member 10 could be molded completely around the stiffener member 12, such that the stiffener member is encased inside the seal member 10. It will be appreciated that other composite structure configurations could also be used to integrate the stiffener member 12 with the seal member 10.

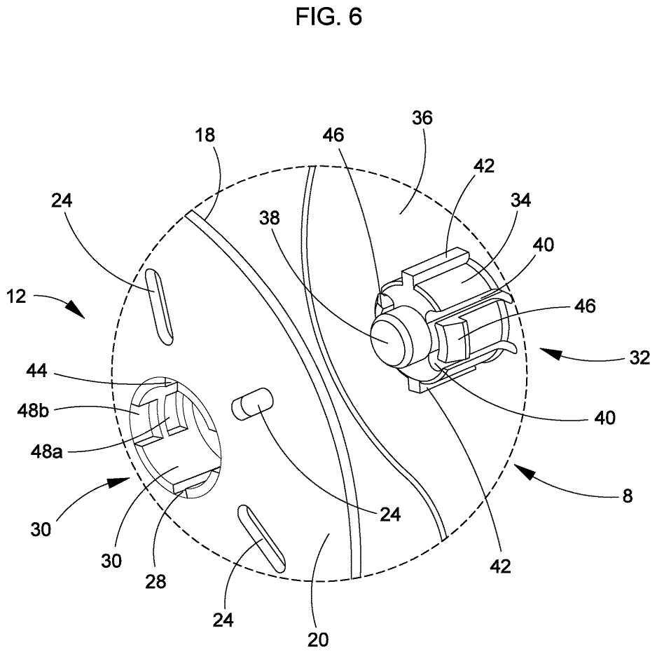

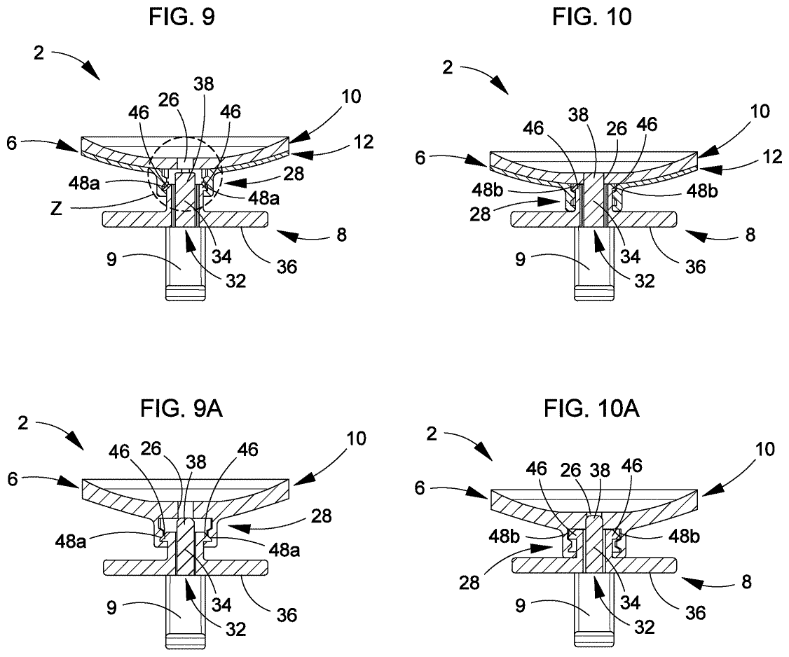

As shown in FIG. 5, the seal member 10 is formed with a central seal member vent port 26 that extends therethrough from the seal member outer side 14 to the seal member inner side 16. As shown in FIGS. 4-5, and with additional reference to FIG. 6, the stiffener member 12 is formed with a collar 28 (best shown in FIG. 4) having a collar opening 30 (best shown in FIG. 6). As can be seen in FIG. 5, the collar opening 30 may be formed as a collar throughbore that is aligned and in fluid communication with the seal member vent port 26. In alternative embodiments, (not shown), a collar (with a collar opening) could be formed as part of the seal member 10. Such a collar could, for example, extend rearwardly from the seal member outer side 14 and pass through a central opening formed in the stiffener member 12. In other alternative embodiments (not shown), a collar (with a collar opening) could be formed by a combination of the seal member 10 and the stiffener member 12. For example, an exterior shell portion of such a collar could be provided by the stiffener member 12 and an interior liner portion of the collar that defines the collar opening 30 could be formed by the seal member 10. In still further alternative embodiments, a collar (with a collar opening) could be formed entirely by the seal member 12 or a modified version thereof. For example, FIGS. 9A, 10A and 11A depict an embodiment similar wherein the collar 28 is provided by a unitary stem portion of the seal member 10 that extends rearward from the seal member outer side. The collar opening may have the same configuration as shown in FIGS. 9, 10 and 11, but with the opening being formed as a stem throughbore extending from the seal member vent port 26 to an opening at a free end of the stem, with the throughbore and the seal member vent port being aligned and in fluid communication with each other.

As will now be described, embodiments in which a collar is provided at least in part by the stiffener member 12 are advantageous because they allow the stiffener member flexing force to be applied directly onto the stiffener member by way of the push-pull member 8 engaging the outer end of the collar. On the other hand, embodiments in which a collar is provided at least in part by the seal member 10 are advantageous because the elastomeric material of the seal member may facilitate beneficial operation of the push-pull member 8, which is used seal and unseal the seal member vent port 26, as also described below.

As shown in FIGS. 5-6, the push-pull member 8 is formed with a plunger valve 32 having a plunger valve stem 34 and a plunger valve head 36. The plunger valve head 36 is configured for engagement by a user of the suction apparatus 2 (e.g., a user's fingers and/or thumb) to receive the stiffener member flexing force (at the outer side of the plunger valve head) and apply it to the stiffener member 12 (at the inner side of the plunger valve head).

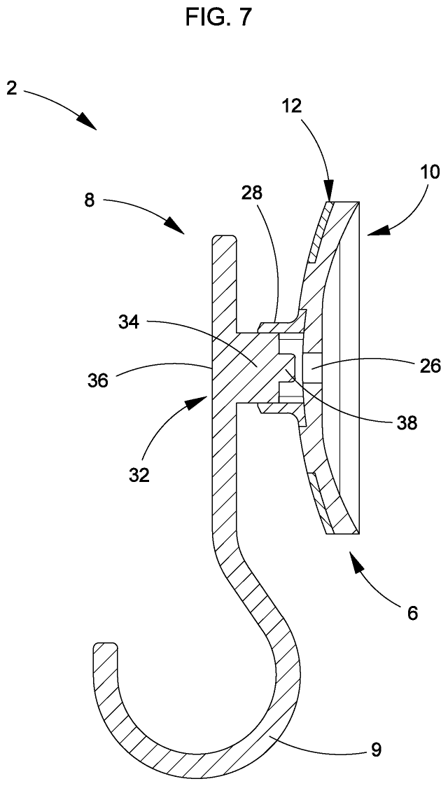

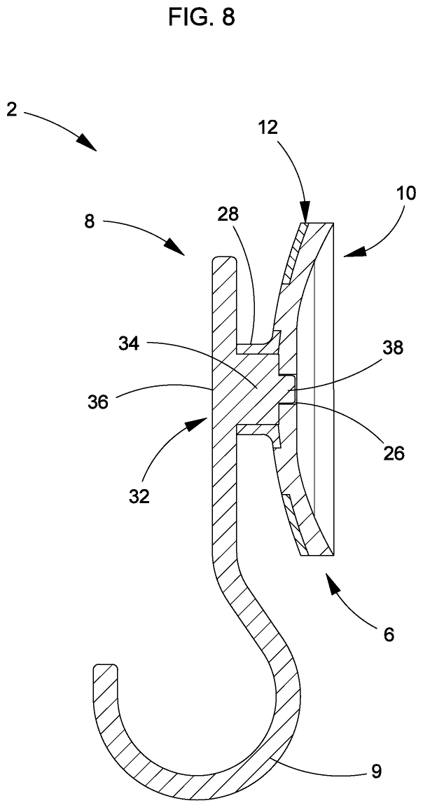

The plunger valve stem 34 is slidably disposed in the collar opening 30. More particularly, and with additional reference to FIGS. 7 and 8, the plunger valve stem 34 is slidable between an open position of the plunger valve 32 wherein the seal member vent port 26 is open (FIG. 7), and a closed position (FIG. 8) of the plunger valve wherein the seal member vent port is closed.

In the plunger valve closed position of FIG. 8, the plunger valve stem 34 blocks the seal member vent port 26 in order to seal it. To that end, the plunger valve stem 34 may be formed with a valve stem tip 38 that inserts and penetrates into the seal member vent port 26 with a slight interference fit. Other sealing configurations could also be used. In the closed position of the plunger valve 32, the inner side of the plunger valve head 36 also engages the outer end of the collar 28, thereby allowing the stiffener member flexing force to be applied directly and forcefully onto the stiffener member 12 by way of the push-pull member 8.

In the plunger valve open position of FIG. 7, the plunger valve stem 34 is slidably retracted so that the stem tip 38 is withdrawn from the seal member vent port 26. In this position, air is free to flow through the seal member vent port 26 between the seal member outer side 14 and the seal member inner side 16. As shown in FIG. 6, one or more longitudinal vent channels 40 may be formed on the plunger valve stem 34 to allow air to pass by the plunger valve stem through the collar opening 30 to the ambient atmosphere.

As additionally shown in FIG. 6, the collar opening 30 and the plunger valve stem 34 may include structural features that constrain movement of the plunger valve stem 34. For example, the plunger valve stem 34 may be formed with longitudinal guide ribs 42 (two are shown) on its outside diameter, and the collar 28 may be formed with mating longitudinal guide channels 44 (two are shown) on its inside wall. The longitudinal guide ribs 42 engage the longitudinal channels 44 in order to prevent rotation of the plunger valve stem 34 in the collar opening 30 while still allowing the plunger valve 32 to slide. In alternative embodiments, rotation prevention could be provided using other anti-rotation plunger/guide configurations, such as by forming the plunger valve stem 34 and the collar opening 30 with a non-circular configuration (e.g., elliptical, polygonal or other rotation-preventing shapes) or by providing a circular or other rotatable configuration but with additional guides, ribs, keys or other formations or structures that interlock to prevent rotation while allowing slidable movement. A further embodiment could be provided in which an anti-rotation configuration is provided outside the collar opening 30. In still other alternative embodiments (not shown) a plunger/guide channel configuration could be used that allows free rotation of the push-pull member 8 relative to the base seal assembly 6, such as by modifying the structure shown in FIG. 6 to remove the longitudinal guide ribs 42 from the plunger valve stem 34 and the guide channels 44 from the collar opening 30.

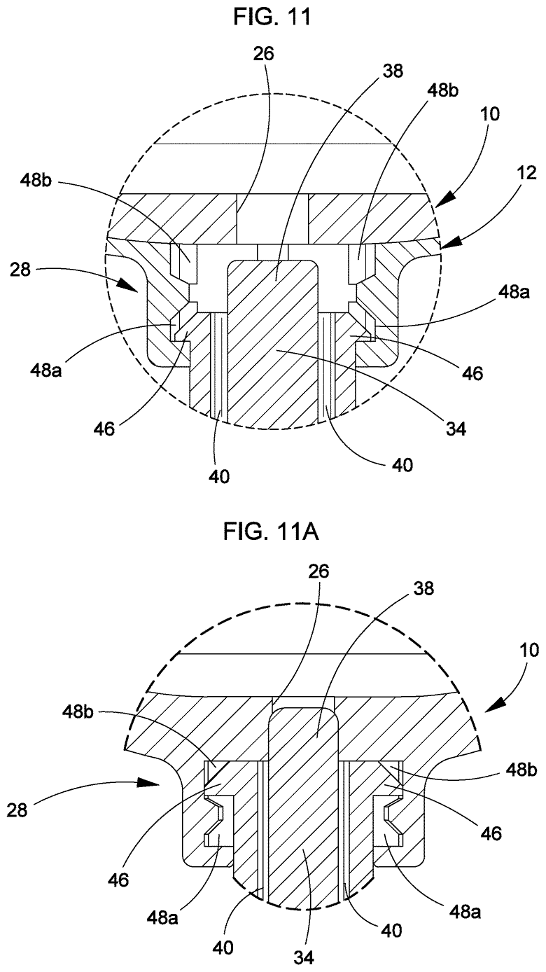

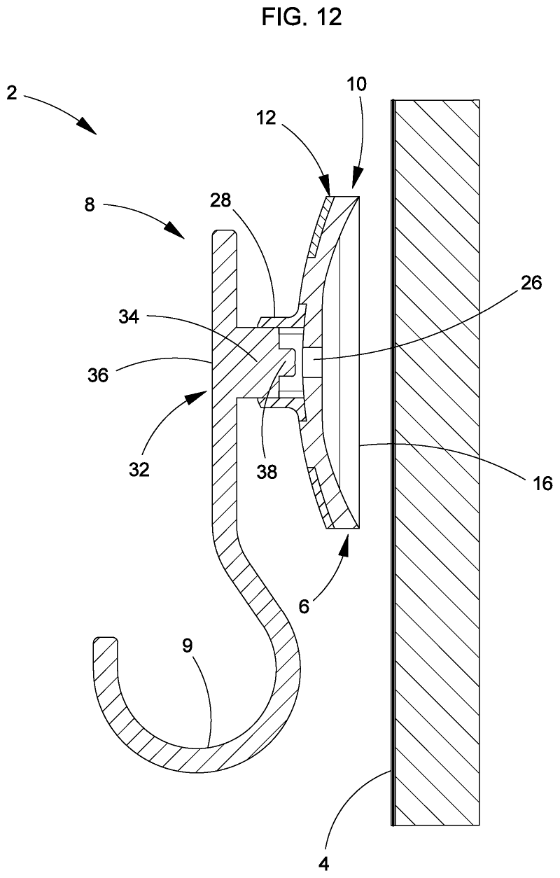

As also depicted in FIG. 6, the plunger valve stem 34 may be further formed with flexible plunger valve retention tabs 46 (two are shown) to serve as collar engagement structures. The retention tabs 46 may be arranged to selectively engage outer retention pockets 48a and inner retention pockets 48b that may be formed on the inside wall of the collar 28, depending on the axial position of the plunger valve 32. For example, as shown in FIGS. 9-11, the retention tabs 46 may lock into the outer retention pockets 48a when the plunger valve 32 is in its open position (FIGS. 9 and 11), and may lock into the inner retention pockets 48b when the plunger valve is in its closed position (FIG. 10).

The outer retention pockets 48a inhibit the plunger valve stem 34 from being removed from the collar 28. Without the outer retention pockets 48a, the push-pull member 8 might inadvertently detach from the base seal assembly 6 during removal of the suction apparatus 2 from the reference surface 4. The inner retention pockets 48b inhibit the plunger valve stem tip 38 from being withdrawn from the seal member vent port 26. Without the inner retention pockets 48b, the seal member 10 might prematurely vent and detach from the reference surface 4 while the suction apparatus 2 is in use.

As can be seen in FIG. 11, the previously-described longitudinal vent channels 40 extend underneath the retention tabs 46, the latter being cantilevered from the inner side of the plunger valve head 36, as is apparent from FIGS. 9 and 10. This allows the retention tabs 46 to deflect radially inwardly as the push-pull member 8 is pushed and pulled to effect the open and closed positions of the plunger valve 32. As can be additionally seen in FIG. 11, the inner side of the outer retention pockets 48a and the outer side of the inner retention pockets 48b are formed as static cam surfaces that are angled to urge the retention tabs 46 inwardly as cam followers when the plunger valve stem 34 slidably displaces within the collar opening 30 between the open and closed positions of the plunger valve 32.

Although not shown, it should be understood that alternative embodiments of the suction apparatus 2 could be implemented in which the push-pull member 8 is formed with a collar-enveloping structure that concentrically surrounds the plunger valve stem 34 and slidably envelops the outer surface of the collar 28. In that case, retention elements could be respectively formed on the collar-enveloping structure's inner surface and the collar member's enveloped outer surface. Such retention elements could be provided in lieu of (or in addition to) the retention tabs 26 and the outer and inner retention pockets 48a and 48b.

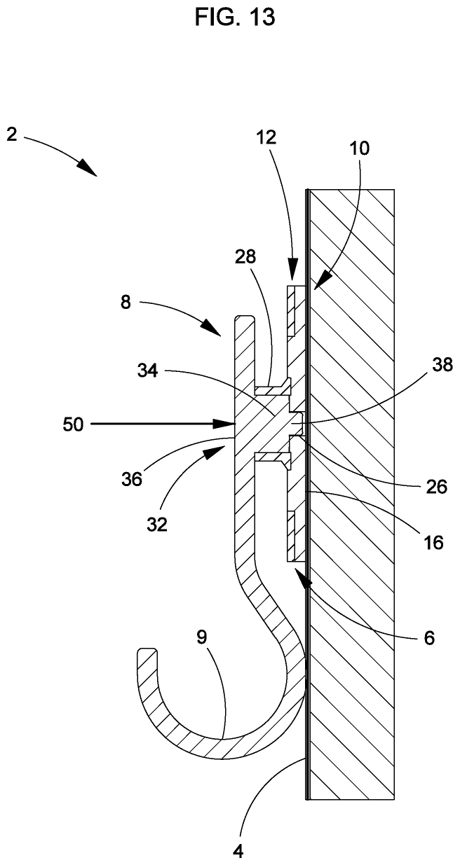

Turning now to FIGS. 12-14, the suction apparatus 2 may be adhered to the reference surface 4 in a manner now to be described. FIG. 12 depicts a first stage placement maneuver in which a user grasps the push-pull member 8 and advances the suction apparatus 2 toward the reference surface 4. During the placement maneuver, the stiffener member 12 is in its initial unflexed cambered configuration. In this configuration, the stiffener member 12 imparts a camber to the seal member that results in the seal member inner side 16 defining a concavity. At the outset of the placement maneuver, the push-pull member 8 will typically be arranged with the plunger valve 32 in its open position, as shown. Alternatively, the plunger valve 32 could already be in its closed position. The placement maneuver ends when the cambered seal member inner side 16 is placed against the reference surface 4 in contacting relationship therewith.

FIG. 13 depicts a second stage pressing maneuver in which the user presses on the plunger valve head 36 of the push-pull member 8 in order to advance the plunger valve 32 into its closed position. This assumes that the plunger valve 32 was initially in its open position. As noted above, this may not always be the case. Once the plunger valve 32 in its closed position, the user may apply the stiffening member flexing force (shown by arrow “50”) against the outer side of the plunger valve head 36. Because the inner side of the plunger valve head 36 directly engages the outer (free) end of the collar 28 in this position, the stiffener member flexing force will be applied directly and forcefully onto the stiffener member 12 by the plunger valve head 36. The stiffener member 12 will thereby elastically deform into its flattened flexed state wherein the initial stiffener member camber is wholly or partially eliminated. This in turn flattens the seal member 10 against the reference surface 4, thereby wholly or partially eliminating its initial seal member camber.

In regard to the second stage pressing maneuver, it should be noted that the force required to advance the plunger valve 32 into its closed position, which can be referred to as a vent port sealing force, may be smaller than the stiffener member flexing force 50. In that case, the pressing maneuver will be characterized by two-distinct pressing phases. The first pressing phase will be a plunger valve closing phase that results from the user initially pressing on the plunger valve head 36 with the smaller vent port sealing force in order to close and seal the seal member vent port 26. At the end of the first pressing phase, the seal member 10 will be in initial sealing engagement with the reference surface (due to the seal member vent port 26 being closed), but may still be unflattened or only partially flattened. The second pressing phase will be a stiffener member flexing phase that results when the user increases the pressing force on the plunger valve head 36 until such force equals (or exceeds) the stiffener member flexing force 50. At the end of the second pressing phase, the seal member 10 will be wholly or partially flattened against the reference surface 4, as depicted in FIG. 13.

It will be appreciated that alternative embodiments of the suction apparatus 2 could be implemented in a manner that results in the vent port sealing force being equal to the stiffener member flexing force 50, such that the vent port 26 is closed and sealed at the same time that the seal member 10 becomes maximally flattened. In a still other alternative embodiments of the suction apparatus 2, the vent port sealing force could be larger than the stiffener member flexing force 50, such that the vent port 26 is closed and sealed only after the seal member 10 becomes maximally flattened.

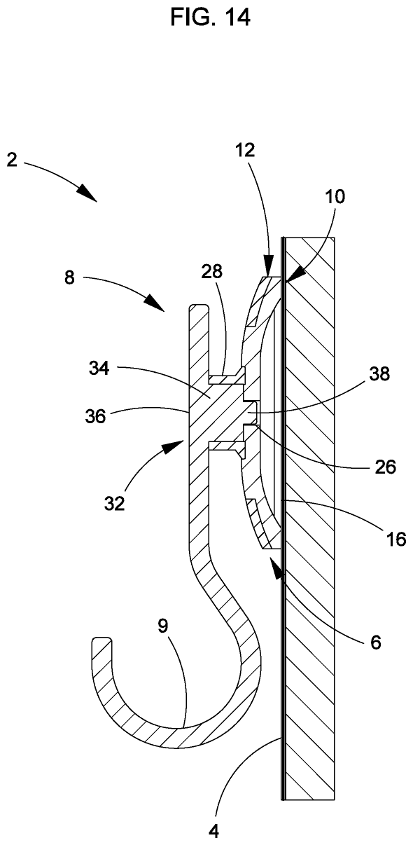

FIG. 14 depicts a third stage suction-setting maneuver in which the user removes the stiffener member flexing force 50. This causes the stiffener member 12 to elastically rebound toward its unflexed cambered state, thereby also un-flattening the seal member 10 by wholly or partially restoring its seal member camber. As the seal member 10 becomes cambered, its seal member inner surface 16 begins to form a concavity relative to the reference surface 4. This causes a strong suction force to develop between the seal member first side 16 and the reference surface 4. The suction force increases as the camber of the seal member 10 becomes larger until an equilibrium condition is reached in which the suction force equals the elastic rebound (spring-back) force applied by the stiffener member 12.

When it is desired to remove the valve-actuated suction apparatus 2 from the reference surface 4, the user only needs to pull the push-pull member 8 by grasping the plunger valve head 36 and pulling it (away from the direction of the reference surface 4). This action withdraws the plunger valve stem 34 out of engagement with the seal member vent port 26 as the plunger valve 32 moves from its closed position to its open position to release the suction force between the seal member inner side 16 and the reference surface 4.

Accordingly, a valve-actuated suction apparatus 2 has been disclosed that includes a base seal assembly 6 formed by a highly elastomeric seal member 10 and an integrated suction-enhancing stiffener member 12. The suction apparatus 2 further includes a convenient push-pull member 8 formed with a plunger valve 32 for efficient user-friendly flexing of the stiffener member 12 and rapid seal-and-release of the seal member 10.

Although the suction apparatus 2 has been described and shown in the context of certain example embodiments, it should be apparent that variations and alternative embodiments could be implemented in accordance with the present disclosure. The disclosed suction apparatus 2 may, for example, be embodied in many different shapes and sizes to operate with many different types of auxiliary structures that can be combined therewith, including but not limited to bowls, buckets, cans, vases, urns, tanks, or other apparatus whose function is to hold or carry an object or material. Alternatively, the auxiliary structures may themselves represent objects or materials to be anchored instead of being holders or carriers for other objects or materials. Examples of such auxiliary structures include tools, implements, devices, equipment or other articles that could be integrated with, attached to, mounted on, or formed with the disclosed suction apparatus 2. Broadly speaking, the disclosed suction apparatus 2 may be used for anything imaginable that a user might wish to anchor to a reference surface 4. Alternatively, it should be understood that the disclosed suction apparatus 2 may be used for applications that do not involve auxiliary structures or the anchoring of object or materials other than the suction apparatus itself. Examples include medical applications such as therapeutic massage cupping, lifting applications such as sheet glass installation, retaining applications wherein two or more instances of the suction apparatus 2 are situated around an object to serve as movement limiting stop members, and novelty/amusement applications.

Reference in the present disclosure to an “embodiment” means that a particular feature, structure or characteristic described in connection with the embodiment may be included in at least one embodiment of the disclosed apparatus. Thus, the appearances of the term “embodiment” in various places throughout the specification are not necessarily all referring to the same embodiment.

For purposes of explanation, specific configurations and details have been set forth herein in order to provide a thorough understanding of the present invention. However, it will be apparent to one of ordinary skill in the art that embodiments of the present invention may be practiced without the specific details presented herein. Furthermore, well-known features may have been omitted or simplified in order not to obscure the present invention. Various examples may be given throughout this description. These examples are merely descriptions of specific embodiments of the invention. The scope of the invention is not limited to the examples given.

As used in this application, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” and other orientational descriptors are intended to facilitate the description of the example embodiments of the present disclosure, and are not intended to limit the structure of the example embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Terms of rough approximation, such as “generally,” are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

It is understood, therefore, that the invention is not to be in any way limited except in accordance with the spirit of the appended claims and their equivalents.

What is claimed is:

1. A valve-actuated suction apparatus, comprising:
an elastomeric seal member;
the seal member being arranged to seal against a surface and having a vent port extending therethrough;
a collar having a collar opening extending therethrough that is aligned and in fluid communication with the vent port; and
a plunger valve slidably arranged in the collar opening in a manner that prevents rotation of the plunger valve relative to the collar, the plunger valve being slidable between a plunger valve closed position and a plunger valve open position to selectively seal and unseal the seal member vent port.

2. The apparatus of claim 1, wherein the plunger valve rotation is prevented in all operational positions of the plunger valve.

3. The apparatus of claim 1, wherein the plunger valve rotation is prevented by virtue of a structure on the plunger valve engaging a structure in the collar opening.

4. The apparatus of claim 1, wherein the plunger valve rotation is prevented by virtue of a structure on the plunger valve slidably engaging a structure in the collar opening.

5. The apparatus of claim 1, wherein the plunger valve rotation is prevented by virtue of a protruding structure on the plunger valve slidably engaging a recessed structure in the collar opening.

6. The apparatus of claim 1, wherein the plunger valve rotation is prevented by virtue of a longitudinal guide rib engaging a longitudinal channel.

7. The apparatus of claim 1, wherein the plunger valve rotation is prevented by virtue of a longitudinal guide rib on the plunger valve engaging a longitudinal channel in the collar opening.

8. The apparatus of claim 1, wherein the collar opening comprises a first plunger valve retention structure that engages a collar engagement structure on the plunger valve when the plunger valve seals the seal member vent port and a second a plunger valve retention structure that engages the collar engagement structure when the plunger valve unseals the seal member vent port.

9. The apparatus of claim 8 wherein the first plunger valve retention structure and the second plunger valve retention structure respectively comprise a first retention pocket and a second retention pocket, and wherein the collar engagement structure comprises a plunger valve retention tab.

10. The apparatus of claim 1, wherein the plunger valve resides in the collar opening while in the plunger valve closed position and plunger valve open position, and enters the seal member vent port for vent port sealing in the plunger valve closed position.

11. The apparatus of claim 1, wherein the plunger valve comprises a plunger valve stem formed with a valve stem tip, the plunger valve stem residing in the collar opening while the plunger valve is in the plunger valve closed position and plunger valve open position, and the valve stem tip entering the seal member vent port for vent port sealing when the plunger valve is in the plunger valve closed position.

12. The apparatus of claim 11, wherein the valve stem tip is sized to insert and penetrate into seal member vent port when the plunger valve is in the plunger valve closed position.

13. The apparatus of claim 12, wherein the valve stem tip engages the seal member vent port with an interference fit.

14. The apparatus of claim 12, wherein the plunger valve stem comprises a vent channel that allows air to pass by the plunger valve stem through the collar opening when the plunger valve is in the plunger valve open position.

15. The apparatus of claim 12, wherein the plunger valve rotation is prevented by virtue of a longitudinal guide rib on the plunger valve stem engaging a longitudinal channel in the collar throughbore.

16. The apparatus of claim 12, wherein the collar throughbore comprises a first plunger valve retention structure that engages a collar engagement structure on the plunger valve stem when the plunger valve seals the seal member vent port and a second a plunger valve retention structure that engages the collar engagement structure when the plunger valve unseals the seal member vent port.

17. The apparatus of claim 1, wherein the collar comprises part of the seal member.

18. The apparatus of claim 1, wherein the collar is formed by a structure other than the seal member, or by a combination of the seal member and a structure other than the seal member.

19. The apparatus of claim 1, wherein the structure other than the seal member comprises a stiffener integrated with the seal member.

20. A method of use for the valve-actuated suction apparatus of claim 1, comprising (in any order):
adhering the valve-actuated suction apparatus to a surface by placing the seal member against the surface so that the seal member is in sealing contact with the surface;
pressing the plunger valve into the plunger valve closed position to thereby seal the vent port; and
attempting to rotate the plunger valve relative to the collar while being prevented from doing so due to the plunger valve being slidably arranged in the collar opening in a manner that prevents rotation of the plunger valve relative to the collar.
